(19) United States
(12) Patent Application Publication
(10) Pub. No.: US 2007/0128078 A1
(43) Pub. Date: Jun. 7, 2007

(54) Lab-on-a-chip comprising a coplanar microfluidic system and electrospray nozzle

(76) Inventors: Nicolas Sarrut, Seyssinet-Pariset (FR); Olivier Constantin, Grenoble (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/587,852

(22) PCT Filed: Jan. 28, 2005
(86) PCT No.: PCT/FR05/50053

§ 371 Date: Jul. 28, 2006

(30) Foreign Application Priority Data
Jan. 30, 2004 (FR) 0450173

(51) Int. Cl. B01L 3/00

(52) U.S. Cl. 422/99

(57) ABSTRACT

The invention relates to an on-chip laboratory comprising a fluidic network made in a substrate, a fluid inlet orifice connected to the fluidic network and a fluid outlet orifice connected to the fluidic network. The substrate comprises a planar layer (53) in which the fluidic network and an electronebulization nozzle (65) are made, the electronebulization nozzle overhanging relatively to the remainder of the substrate (51, 52) and comprising a channel (64), one end of which is connected to the fluidic network and the other end of which forms said fluid outlet orifice, the channel being fitted with electrical conduction means (59) forming at least one electrode.

### TECHNICAL FIELD

The invention relates to an on-chip laboratory comprising a coplanar micro-fluidic network and electronebulization nose. In particular, it relates to the coupling of an on-chip laboratory with a mass spectrometer.

For now ten years, many ways have been explored for coupling different micro-fluid devices to mass spectrometers. Indeed, optical detection methods like spectrophotometry or fluorescence are not suitable for detecting biomolecules such as proteins or peptides, a detection which particularly concerns the field of proteomics. The limits are either the sensitivity or the necessity of preparing the sample (fluorescent marking), which, in the case of identifying proteins after enzymatic digestion, has a problem as the obtained peptides are a priori not known. Mass spectrometry is therefore often retained as it gives information on the nature of the analyzed samples (intensity spectrum according to the mass/charge ratio) with very good sensitivity (femtomol/μl), and it enables complex mixtures of molecules to be analyzed. For this, it is often necessary that pre-treatment of the sample be performed upstream from the analysis. For example, this pre-treatment consists in separating chemical and/or biological compounds, preceded and/or followed by concentration of the species.

In order to perform this continuous pre-treatment together with the analysis in a minimum time and minimize the volumes of reagents used, it is possible to take advantage of the recently accomplished advances in the field of microfluidics. As examples, microfluidic devices for enzymatic digestion (Lian Ji Jin, “A microchip-based proteolytic digestion system driven by electroosmotic pumping”, Lab Chip, 2003, 3, 11-18), for capillary electrophoresis (B. Zhang et al., “Microfabricated Devices for Capillary Electrophoresis-Electrospray Mass Spectrometry”, Anal. Chem., Vol. 71, No. 15, 1999, 3259-3264) or for 2D separation (J. D. Ramsey, “High-efficiency Two-dimensional Separations of Protein Digests on Microfluidic Devices”, Anal. Chem., 2003, 75, 3758-3764 ou N. Gottschlich et al., “Two-Dimensional Electrochromatography/Capillary Electrophoresis on a Microchip”, Anal. Chem. 2001, 73, 2669-2674) have already been presented.

The microfluidics/mass spectrometry coupling may be based on a technique for ionizing the sample by electronebulization or electrospray (ElectroSpray Ionization (ESI)). At atmospheric pressure and immersed in a strong electric field, the pre-treated liquid sample leaving the microfluidic chip is nebulized into a gas of ions or into a multitude of charged droplets which may enter the mass spectrometer (SM) for analysis. This nebulization requires deformation of the interface formed between the leaving liquid and the surrounding gas (liquid/gas meniscus) and the liquid <<drop>> assumes a conical shape called a <<a Taylor cone>>. The volume of this cone forms a dead volume for the leaving liquid (a geometrical space in which the chemical compounds may mix), which is not desirable, especially when the last pre-treatment step in fact consists in separating the chemical compounds from the sample. This is why one always seeks to minimize the size of this cone, and this requires i.a. reduction of the inner and outer dimensions of the outlet channel of the microfluidic chip.

Conventionally, during analysis by mass spectrometry, the sample is pre-treated <<outside the ESI device>> and manually placed (with the pipette) in a hollow needle, the end of which is electrically conducting (the <<PicoTip emitter>> from New Objective for example). An electrical field is imposed between the conducting portion of the PicoTip and the entrance of the SM, with which a Taylor cone may be formed at the outlet of the PicoTip and the sample nebulized. The <<pointed>> cylindrical geometry of the PicoTips is ideal for forming a small Taylor cone, but the limits on minimization of their size (conventionally with an outer diameter of 360 um and an inner diameter of 10 μm), those limits on obtaining good reproducibility with the manufacturing techniques used (drawing process) and their brittleness upon use are the main reasons for trying to make other types of nebulization devices.

In the literature, when these devices are developed with micro-technologies such as silicon planar technologies for example (etching, machining, thin film depositions and photolithography of different materials on substrates having very large side dimensions relatively to their thickness), these are often designated as <<electrospray nozzles>> (Tai et al., “MEMS electrospray nozzle for mass spectroscopy”, WO-A-98/35376). The stake of such realizations is double.

On the one hand, with micro-technologies, ESI interfaces may be made by defining tip type structures (like the PicoTips) but smaller (to limit the volume of the Taylor cone), more reproducible and less brittle structures, which are of interest per se (see document WO-A-00/30167).

On the other hand, with micro-technologies, devices may be made which integrate a fluidic network with which pre-treatment of the sample and an interface of the ESI type may be provided. In addition to the aforementioned advantages (reduction in the output dead volumes, reproducibility, robustness of the ESI interface), one benefits from those related to an integrated pre-treatment device (continuous pre-treatment protocol with analysis, reduction in the global analysis times, minimization of the volumes of reagents).

Nevertheless, such integration poses three major technological design problems:
Firstly, the technology for making the device should be compatible with that of a pre-treatment fluid network (reservoirs, micro-channels, reactors . . . ) and of an ESI interface (tip geometry, minimum outlet dimensions . . . ), and this in order to produce the complete device on a same support or a same set of supports seeing to technological continuity common to both integrated entities.
Secondly, it should be devised so as not to add additional dead volume to those which may exist in the pre-treatment fluid network and in the ESI interface taken separately.
Finally, it should provide the ESI interface with a nebulization electrode without adding dead volume to the system. This nebulization electrode may be localized either outside the tip structure (M. Svederberg et al., “Sheathless Electrospray from Polymer Microchips”, Anal. Chem., 2003, 75, 3934-3940), i.e., inside the outlet channel and near the outlet of the device. In the first case, an electric field is exclusively imposed outside the device, in the air (or another gas) portion located between the end of the tip and the entrance of the SM. In the second case, an electric field also exists inside the device, in the liquid segment located between the electrode and the end of the tip. For setting up an external electrode, it is often reported (R. B. Cole, “Electrospray ionization mass spectrometry: fundamentals, instrumentation and applications”, John Wiley & Sons: New York, 1997) that a main difficulty is to provide it with sufficient robustness. Indeed, conductive coatings made for this purpose very often deteriorate too rapidly under the action of strong electric fields.

### STATE OF THE PRIOR ART

As early as 1997, R. S. Ramsey and J. M. Ramsey (“Generating Electrospray from Microchip Devices Using Electroosmotic Pumping”, Anal. Chem., 1997, 69, 1174-1178) proposed a glass microfluidic chip, the liquid flows of which are generated by electro-osmotic pumping and the output channel of which opens into the section of the component with a planar geometry. Under the assistance of overpressure imposed upstream, a sample drop of 12 nl forms at the chip outlet, which drop under the action of a strong electric field forms a Taylor cone and is nebulized. This simple approach poses the problem of a significant liquid dead volume (12 nl), whence a sensitivity limit of the device.

More recently, K. Huikko et al. (“Poly(dimethylsiloxane) electrospray devices fabricated with diamond-like-carbon poly (dimethylsiloxane) coated SU-8 masters”, Lab Chip, 2003, 3, 67-72) proposed a poly(dimethylsiloxane) (PDMS) chip, it also having opening channels intended to be put opposite a SM for nebulizing the sample. The authors take advantage of the hydrophobicity of PDMS for obtaining a small Taylor cone, whence the limitation of the dead volume at the outlet. Nevertheless, the proposed device does not integrate any nebulization electrode. The tests were carried out by using a platinum wire dipping in the inlet reservoir of the ESI channel; this cannot be a good solution, i.e., without adding any dead volume, for possible integration to a pre-treatment fluid network. Moreover, PDMS technology remains a limited technology which does not yet allow the design of complex microfluidic networks with a characteristic size of the order of one micrometer. This imposes a strong limitation as to the pattern of the microfluidic entities required for pre-treatments of samples (concentration, separation . . . ).

M. Svederberg et al. (“Sheathless Electrospray from Polymer Microchips”, Anal. Chem., 2003, 75, 3934-3940) propose polymer devices which have very interesting geometries for making electrospray nozzles (2D or 3D tips) but the dimensions of the outlet channel (width 100 μm×height 70 μm) obtained by their machining technology are redhibitory for making a device with small dead volumes. Indeed, it is recalled that the outlet diameter of a PicoTip is only 10 μm. In addition, the use of polymer materials imposes strong limits as to possible chemical for biological functionalizations of the internal walls of the outlet channel or of a possible sample pre-treatment fluidic network. Indeed, up to now, most of these functionalizations were developed on silicon or on glass. Moreover, the proposed manufacturing technology is not collective and the nebulization electrode is made on the outer portion of the ESI tip.

V. Gobry et al. (“Microfabricated polymer injector for direct mass spectrometry coupling”, Proteomics 2002, 2, 405-412), J. Kameoka et al. (“An electrospray ionization source for integration with microfluidic”, Anal. Chem. 2002, 74, 5897-5901) and J. Wen et al. (Electrophoresis 2000, 21, 191-197) also propose making electrospray nozzles in polymer materials with a two-dimensional geometry suitable for forming a stable Taylor cone and limiting the dead volumes. But the technology used does not propose the integration of a nebulization electrode. The tests are made by means of a gold wire dipping in an inlet reservoir of the device.

Another approach consists in adapting the outlet of the separation channel so as to be able to receive a commercial PicoTip (Y. Tachibana et al., “Robust and simple interface for microchip electrophoresis-mass spectrometry”, J. of Chromatography, 1011 (2003), 181-192). This requires the use of a metal and/or plastic part playing a linking role in assembling both entities. This kind of assembly has significant dead volumes and does not solve the problem of using commercial PicoTips having a certain irreproducibility in dimensions and great brittleness upon use.

Two documents from a team of the California Institute Of Technology may also be mentioned: Tai et al., “MEMS electrospray nozzle for mass spectroscopy”, WO-A-98/35376 and Tai et al., “Polymer-based electrospray nozzle for mass spectrometry”, WO-A-00/30167. The claimed technologies for making an electrospray nozzle provided with an upstream filter are surface technologies with which hollow structures may be made in silicon nitride in the first case and in parylene in the second. These surface technologies are based on the use of a sacrificial layer (in phosphosilicate glass (PSG)), which as indicated by its name, is not retained up to the end of the technological continuity. Removal of this layer, performed by chemical etching, determines the hollow structures. From a geometrical point of view, these technologies are of interest (tip shapes of the nozzle), but they do not propose integration of nebulization electrodes and the authors use the standard way with a platinum wire dipping in an inlet reservoir in order to test their system, which is redhibitory for obtaining a complete fluidic system (pre-treatment and electrospray nozzle) with small dead volumes.

Finally, J. E. Moon et al. in U.S. Pat. No. 6,464,866 claim a chemical analysis system made with micro-technology from two substrates, preferably in silicon, and comprising a liquid chromatography system and an electrospray device. The device disclosed in this document includes a tip of the electrospray nozzle, perpendicular to the plane of the substrates used. So this arrangement does not prevent dead volumes due to changes in direction.

### DISCUSSION OF THE INVENTION

The present invention proposes a microfluid device allowing different treatments of samples and having a good interface with an ESI type mass spectrometer, which requires:
a manufacturing technology compatible with that of a pre-treatment fluid network (reservoirs, micro-channels, reactors . . . ) and of an ESI interface at the outlet (geometry with tips, minimum outlet dimensions), and this so that the complete device may be made on a same support or a same set of supports seeing to technological continuity common to both integrated entities.
An integration design without any dead volumes.
Integration of a nebulization electrode inside the outlet channel and near the outlet of the device.

The object of the invention is therefore an on-chip laboratory comprising a support, at least one fluidic network, at least one inlet fluid orifice connected to the fluidic network and at least one fluid outlet orifice connected to the fluidic network, a thin layer integral with the support and in which the fluidic network and an electronebulization nozzle are made, the electronebulization nozzle overhanging relatively to the support and comprising a channel, an end of which is connected to the fluidic network and the other end of which forms said fluid outlet orifice, the channel being fitted with electrical conduction means forming at least one electrode, characterized in that the thin layer is a layer fixed by direct sealing on the support.

The rear face of the support, i.e., the one which does not support the thin layer, may advantageously be of an inert nature. It is then not involved in the operation of the device. In particular, it does not then have any electrical connection.

If the support is a semiconducting material, the electric conduction means may be a doped portion of said support. The support may be in a conducting material.

This laboratory may comprise a cover sealably covering the fluidic network, this cover being provided with a fluid access means at the fluid inlet orifice.

According to another arrangement, the on-chip laboratory may comprise a cover sealably covering the fluidic network, this cover being provided with a fluid access means at the fluid inlet orifice and provided with said electric conduction means.

The cover may be in a conducting material. It may be in a semiconducting material, the electric conduction means may then comprise a doped portion of the cap.

By using a cover, it is possible to seal off the fluidic network.

The electric conduction means may therefore be located both in the support and in the cover and may also be made either with the support or the cover in a conducting material, or with metal tracks deposited on the support or the insulating cover, or may be doped portions of the support or the cover in semiconducting material.

### SHORT DESCRIPTION OF THE DRAWINGS

The invention will be better understood and other advantages and features will be apparent upon reading the description which follows, given as a non-limiting example, accompanied by the appended drawings wherein:

FIG. 1 is a diagram of an on-chip laboratory according to the present invention,

FIG. 2. illustrates the COMOSS structure of an enzyme digestion reactor used in the on-chip laboratory of FIG. 1,

FIG. 2A shows a detail of FIG. 2,

FIG. 3 illustrates the COMOSS structure of a pre-concentration reactor used in the on-chip laboratory of FIG. 1,

FIG. 3A shows a detail of FIG. 3,

FIG. 4 illustrates the COMOSS structure of a chromatography reactor used in the on-chip laboratory of FIG. 1,

FIG. 4A shows a detail of FIG. 4,

FIG. 5 is an enlarged view of a detail of FIG. 1 showing the ESI interface,

FIGS. 6A-6D illustrate a first embodiment of an on-chip laboratory according to the present invention,

FIGS. 7A and 7B illustrate a second embodiment of an on-chip laboratory according to the present invention,

FIGS. 8A-8D illustrate a third embodiment of an on-chip laboratory according to the present invention,

FIGS. 9A-9H illustrate a fourth embodiment of an on-chip laboratory according to the present invention,

FIGS. 10A and 10E illustrate a fifth embodiment of an on-chip laboratory according to the present invention,

FIGS. 11A-11F illustrate a sixth embodiment of an on-chip laboratory according to the present invention,

FIG. 12 illustrates a top view of a substrate comprising a plurality of devices according to the present invention.

### DETAILED DISCUSSION OF PARTICULAR EMBODIMENTS

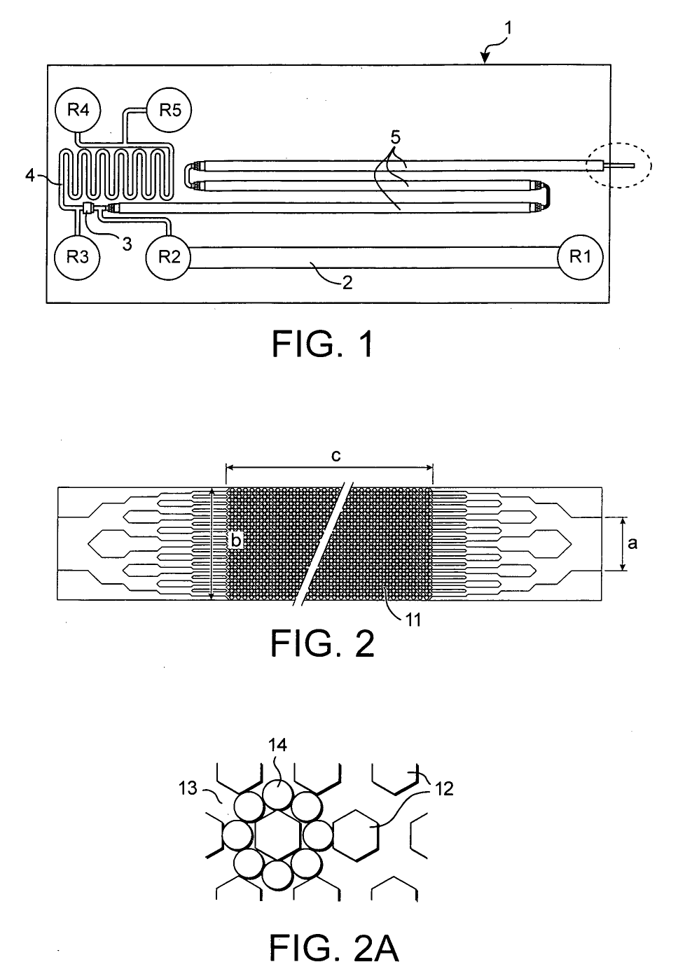

FIG. 1 is a diagram of an on-chip laboratory 1 according to the present invention. This device may have a length of 18 mm by a width of 5 mm.

The Fluidic Network

Firstly the fluidic network intended for preparing a complex biological sample in order to identify the proteic contents is described. This fluidic network consists of a set of reservoirs and channels, an enzyme digestion reactor, a pre-concentration reactor and a reactor for separation by liquid. electro-chromatography. The basic structure of all these reactors is a deep cavity provided with a large number of square or hexagonal section pads . . . . This kind of structure is known as COMOSS (“COllocated MOnolith Support Structures”). Reference may be made on this subject to the article of Bing He et al. entitled “Fabrication of nanocolumns for liquid chromatography”, Anal. Chem. 1998, 70, 3790-3797. For all these reactors, advantage is taken of the large surface/volume ratios developed by these COMOSS structures, ratios which increase the probabilities of encounter between the molecules of the mobile phases (for example proteins for the enzyme digestion reactor) and those of the stationary phases (trypsin for the enzyme digestion reactor).

After complete pre-filling of the fluidic network with buffer, the biological sample (protein) is deposited in the reservoir R1, and then pumped by electro-osmosis from the reservoir R1 to the reservoir R2 through the enzyme digestion reactor 2. Reservoirs with large volumes are positioned between the different reactors of the fluidic network in order to provide a change of buffer between two consecutive steps of the protocol. Thus, R1 contains ammonium bicarbonate ([NH₄HCO₃]=25 mM; pH=7.8), R2, R3 and R4 contain a water/acetonitrile ACN/formic acid TFA (95% ; 5% ; 0.1%) mixtures, whereas R5 contains a water/acetonitrile/formic acid (20% ; 80% ; 0.1%) mixture. The recovered digest in the reservoir R2 has to be concentrated before separation. For this, it is pumped by electro-osmosis towards the reservoir (R3) (rubbish bin). The whole of the peptides resulting from the enzymatic digestion is then <<captured>> by the small volume pre-concentration reactor 3, whence the concentration. An acetonitrile gradient made by mixing the buffer of R4 with that of R5 in the <coil>> type (length 2 cm) structure 4, will then selectively “unhook” the peptides according to their affinity with the stationary phase (for example C18) of the pre-concentration reactor 3. The latter are again <<captured>> by the chromatography column 5, denser than the pre-concentration reactor 3. By enriching the mixture with CAN, it is again possible to selectively “unhook” these peptides from the chromatography column 5, and to carry them off separated, towards the outlet 6 of the chip 1 where the liquid is nebulized towards the inlet of a mass spectrometer not shown.

A reactor with affinity to a given protein (not shown) may be used for sensing the latter in a multi-proteic mixture conveyed through this reactor. For this, a reservoirs/affinity reactor/concentration reactor assembly operating according to the same fluidic principles as described above may be integrated upstream from the fluidic network as described above. The affinity reactor may be functionalized with antibodies and the elution buffer may consist of proteins which are competitive (with regard to the antibody) with the one which one desires to <<capture>> in the multi-proteic complex.

✓ The Upstream Affinity Reactor

With a COMOSS structure, it is intended to specifically sense a protein, a family of proteins, or a multi-proteic complex in the complex biological sample. The tools used for this step may be antibodies, but also small molecules for example which have an interaction specificity with the sought-after protein(s).

✓ The Enzyme Digestion Reactor

The COMOSS structure of the enzyme digestion reactor, illustrated in FIG. 2, is made from a set of hexagonal section pads of 10 μm with which a network of channels of about 5 μm may be defined. Its useful width a is constant 640 μm), but its actual width b is 892 μm. The length c of the active portion of the reactor is 15 mm. Its other geometrical characteristics, to be read in parallel with FIG. 2, are described in the following table:

| | Channel width | Separation walls |
|---|---|---|
| Entity | (μm) | (μm) |
| Linking channel | 640 | 0 |
| Step 1 | 2*320 | 1*128 |
| Step 2 | 4*160 | 3*64 |
| Step 3 | 8*80 | 7*32 |
| Step 4 | 16*40 | 15*16 |
| Step 5 | 32*20 | 31*8 |
| Step 6 | 64*10 | 63*4 |

With this structure, it is optionally possible to organize functionalized (with trypsin for example) <<beads>> of silica of a few micrometers (beads from Bangs Laboratories distributed by Serotec France par example), in order to provide the reactor with its enzymatic properties or to enhance them.

As an example, the enzyme grafted on the pads may be trypsin. The protocol used is the one described in document FR-A-2 818 662.

FIG. 2A shows a detail of the area of the reactor referenced as 11 in FIG. 2. The hexagonal section pads are recognized with which the network of channels 13 may be defined. Reference 14 designates silica beads which may be used.

✓ The Pre-Concentration Reactor

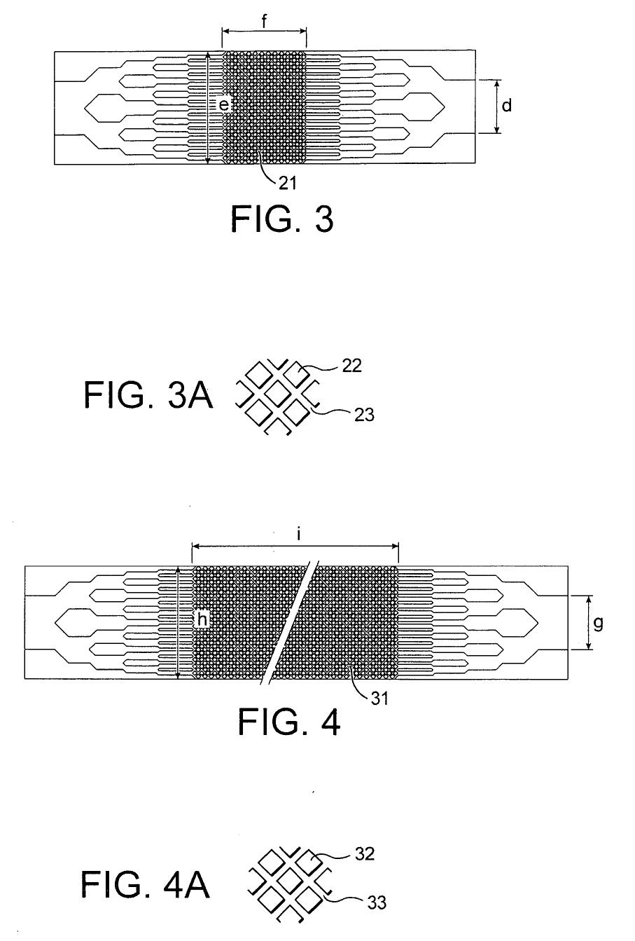

The COMOSS structure of the pre-concentration reactor, illustrated in FIG. 3, is made from a set of pads with 10 μm square sections with which a channel network may be defined of about 2 μm. Its useful width d is constant (160 μm), but its actual width e is 310 μm. The length f of the active part of the reactor is 170 μm. Its other geometrical characteristics, to be read in parallel with FIG. 3, are described in the following table:

| | Channel width | Separation walls |
|---|---|---|
| Entity | (μm) | (μm) |
| Linking channel | 160 | 0 |
| Stage 1 | 2*80 | 1*80 |
| Stage 2 | 4*40 | 3*40 |
| Stage 3 | 8*20 | 7*20 |
| Stage 4 | 16*10 | 15*10 |

With this structure, it may be possible to organize functionalized silica beads in order to provide the reactor with affinity properties or enhance them (C18 grafting for example).

FIG. 3A shows a detail of the area of the reactor referenced as 21 in FIG. 3. The pads 22 with a square section are recognized, with which the channel network 23 may be defined.

✓ The Reactor for Separation by Liquid Electrochromatography

The COMOSS structure of separation reactor, illustrated in FIG. 4, is made from a set of pads with a 10 μm square section with which a channel network of about 2 μm may be defined. Its useful width g is constant (160 μm), but its actual height h is 310 μm. The length i of the active part of the reactor is 12 mm. Its other geometrical characteristics, to be read in parallel with FIG. 4 are described in the following table:

| | Channel width | Separation walls |
|---|---|---|
| Entity | (μm) | (μm) |
| Canal de liaison | 160 | 0 |
| Stage 1 | 2*80 | 1*80 |
| Stage 2 | 4*40 | 3*40 |
| Stage 3 | 8*20 | 7*20 |
| Stage 4 | 16*10 | 15*10 |

For gaining space, the reactor may be made in three portions each with a length of 12 mm as shown in FIG. 1.

With this structure, functionalized silica beads may possibly be organized in order to provide the reactor with its affinity properties or to enhance them (C18 grafting for example).

FIG. 4A shows a detail of the area of the reactor, referenced as 31 in FIG. 4. The pads 32 with a square section are recognized, with which the channel network 33 may be defined.

ESI Interface

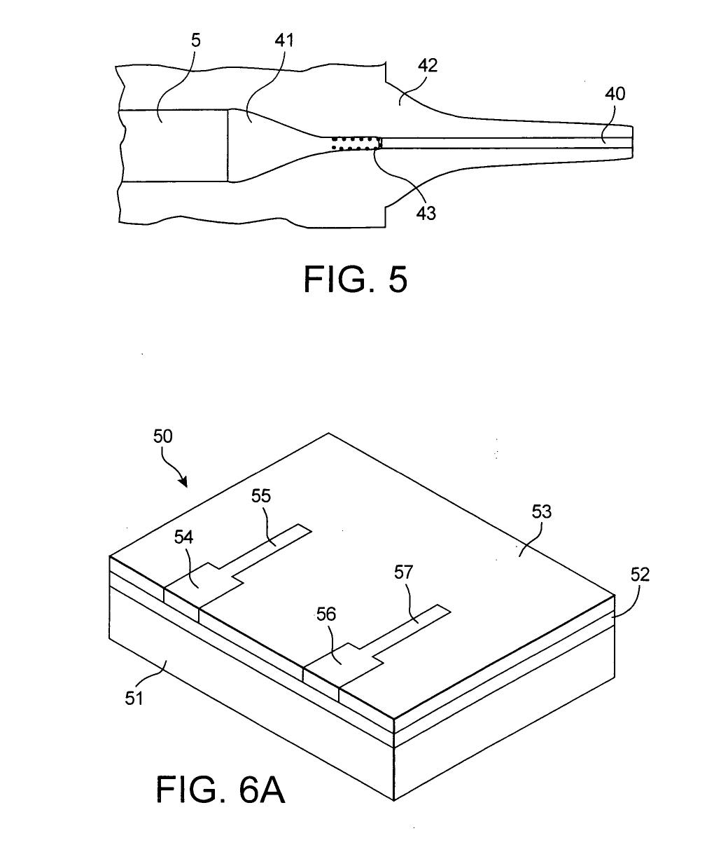

FIG. 5 is an enlarged view of the outlet of the chip, referenced as 6 in FIG. 1. The outlet channel 40 is planar and with a rectilinear axis relatively to the fluidic network. In other words, the outlet channel 40 remains parallel to the planes of the different substrates used for the making. This configuration avoids dead volumes which might be caused by the partial or total path of the thickness of one or more of the substrates, after having covered a portion parallel to the planes of these substrates. Any turn is thereby avoided, which as emphasized earlier, is primordial, notably for conveying samples separated beforehand.

The section of the outlet channel 40 may be adapted by preferentially working on the transverse sides (in the plane of the substrate) of the latter, which provides the possibility of achieving <<mild restrictions>> preventing dead volumes. In FIG. 5, these remarks are illustrated by the existence of a (<<connection>> 41 between the outlet of the channel of the chromatography reactor 5 and the outlet channel 40. Such a restriction is absolutely necessary for connecting fluid structures with <<large>> dimensions (<<large>> volumes, <<large>> affinity capacity for example . . . ) to a structure of the ESI interface type for which, as emphasized earlier, it is desirable to minimize the output surface by typically attaining dimensions of the order of one micrometer to a few micrometers.

At the end of the device, the outlet channel 40 opens into a structure of the tip type 42, a structure with a variable external section with which the surface of the liquid/gas and liquid/solid interfaces may be limited, as exhibited by the out-flowing liquid with its environment, by means of its end with small inner and outer sections, while retaining robustness during its use by its end with a wide section.

Finally, the inside of the outlet channel 40 is provided with an electrode 43 with which an electrical potential may be imposed to the liquid which appears at the outlet of the device, which is necessary for nebulizing the sample (stability of the Taylor cone) and/or participating in its electroosmotic pumping.

The whole of these components provides a complete planar ESI interface, since it is robust, without dead volumes for connecting to fluidic networks and with which a Taylor cone with good stability may be formed.

Different embodiments of the microfluidic device provided with an electro-nebulization structure according to the invention will now be described. Only the preferred embodiment, the fifth one, will be described in detail.

For more clarity, these descriptions are made at the scale of a chip (a device), but the various technological systems are made on substrates which may include several devices (circular 100 mm substrate for example).

In these descriptions, the fluidic network is simplified and reduced to an inlet reservoir, an inlet channel, a microreactor, and an outlet channel with a constant section opening into the tip type structure. One skilled in the art will design the fluidic network as desired, for example the one described earlier.

### First Embodiment

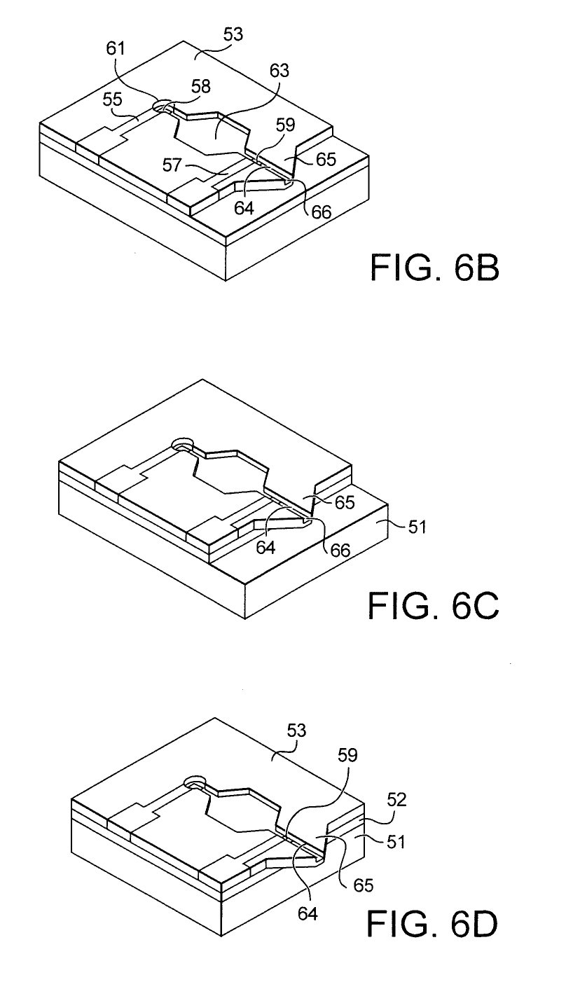

This embodiment is illustrated by FIGS. 6A-6D. It only uses a single substrate SOI. Such substrates are marketed by the <<Soitec>> company. The electrodes, the conducting tracks and the electric contact connections are made in a single step with localized doping of silicon.

FIG. 6A shows a substrate SOI 50 consisting of a silicon support 51 with a thickness of 500 μm, successively supporting a silicon oxide layer 52 with a thickness of 4 μm and a thin silicon layer 53 with a thickness of 25 μm. The thin layer 53 is locally doped in order to provide a first electrically conducting circuit formed with the areas 54 and 55 and a second electrically conducting circuit formed with areas 56 and 57.

The doping of the thin silicon layer 53 is achieved through a photoresist (or silicon oxide) mask over the integrality of the thickness of this layer.

FIG. 6B illustrates the realization of the fluidic network in the thin layer 53. The fluidic network is obtained by <<Deep Reactive Ion Etching>> (DRIE).

The etching of the thin silicon layer 53 is partial (20 μm) in the portion intended to form the fluidic network in order to retain a portion of doped silicon track (5 μm) at the bottom of certain areas of the fluidic network (in particular close to the outlet for making the nebulization electrode). The achieved fluidic network comprises an inlet reservoir 61, an inlet channel 62, a microreactor 63 and an outlet channel 64. At the tip type structure, the outlet channel defined herein then exhibits two side walls and a horizontal wall (the ground). It is noted that an end 58 of the doped area 55 is located at the bottom of the inlet reservoir 61 and that an end 59 of the doped area 57 is located at the bottom of a portion of the outlet channel 64.

This step is a key step as it allows in-depth continuity of the fluidic network and of the outlet channel. Thus, <<zero dead volume>> connector technology is made possible. This will be the case in all the other embodiments.

FIG. 6C illustrates the clearance of the tip. This is obtained by chemically etching the portion of the oxide layer 52 located on the right of the figure.

After this etching, the tip type structure 65 is freed and forms an overhang above the support 51. It should be noted that the outlet channel 64 always includes the bottom 66.

A step for electrically insulating the fluidic network is then performed. This is obtained by thermal oxidization over 3 μm of the thickness of the silicon of the thin layer 53. The silicon support 51 should not be oxidized otherwise the tip type structure 65 would no longer overhang.

This thermal oxidization step is required in order to electrically insulate the liquid present in the fluidic network from the outside. This electrical insulation is necessary, for example when electro-osmotic pumping is used or when a separation by electrophoresis or an electrochemical reaction takes place in the fluidic network.

The next step consists of clearing the electrical contacts. In order to clear the electrodes (ends 58 and 59) and the contact connections (areas 54 and 56), it is necessary to locally etch the thermal SiO₂ layer (3 μm) made earlier. This step may be performed by a laser etching technique as proposed by NovaLase from Pessac (Gironde, France).

In order to obtain the on-chip laboratory according to the invention, support 51 is cleaved as shown in FIG. 6D in order to clear the tip type structure 65.

### Second Embodiment

### Closure with a Structured Pyrex Cover of the Device Described in the First Embodiment

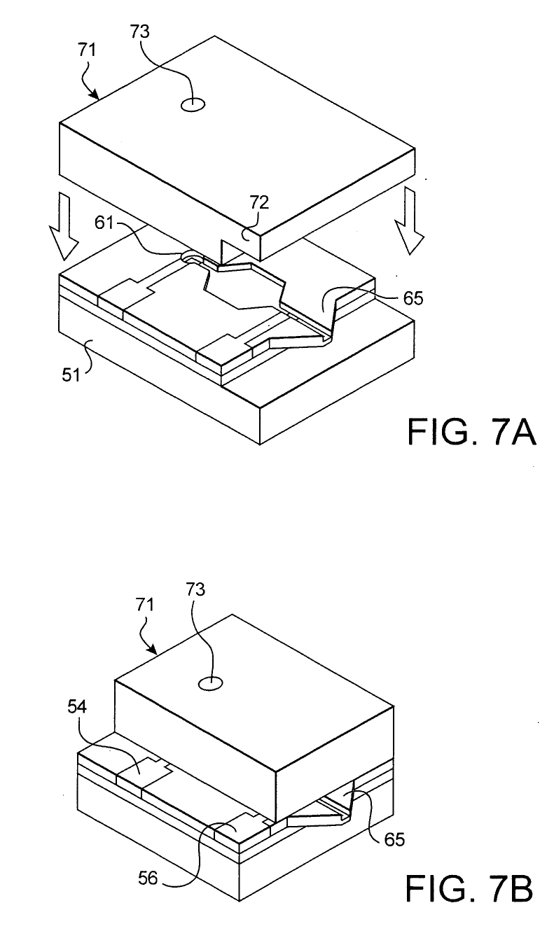

According to this embodiment, the device 70 (see FIG. 7A) obtained by the first embodiment, before the final cleavage step is sealed onto a cover plate 71. The cover plate 71 includes an overhanging end portion 72 so that the plate 71 does not cover the tip type structure 65. It also includes a through-hole 73 intended to provide fluid communication with the inlet reservoir 71 of the device 70. The covering plate 71 may be a pyrex substrate, for example the one available under reference Corning 7740.

Once the seal is obtained, one proceeds with three cleavages. With a first cleavage of the plate 71 and a cleavage of the support 51 of the device 70, the electronebulization nozzle may be freed. With a second cleavage of the plate 71 the contact connections 54 and 56 may be freed.

### Third embodiment

### Alternative of the First Embodiment

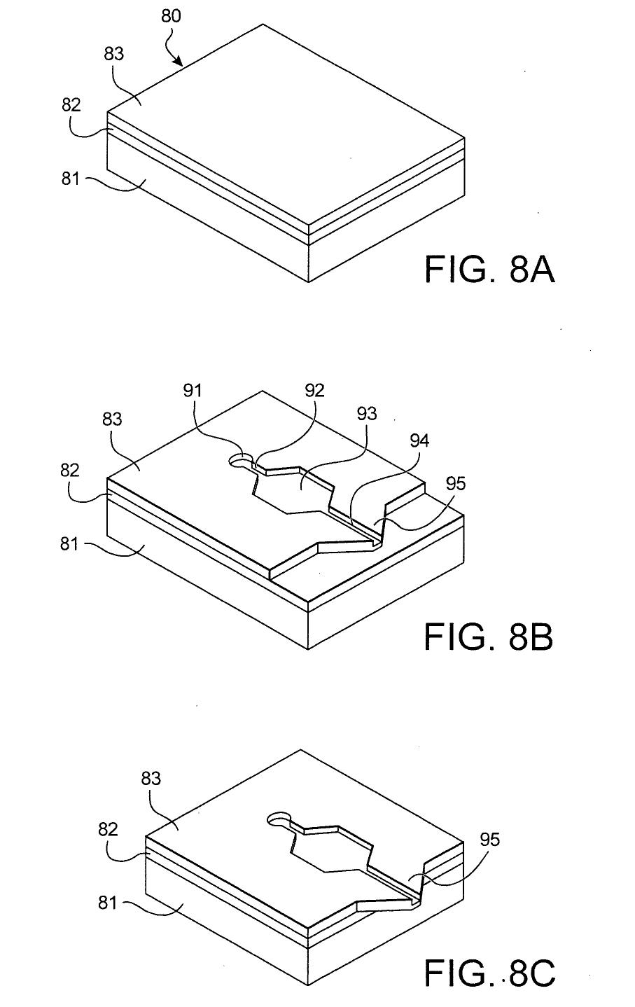

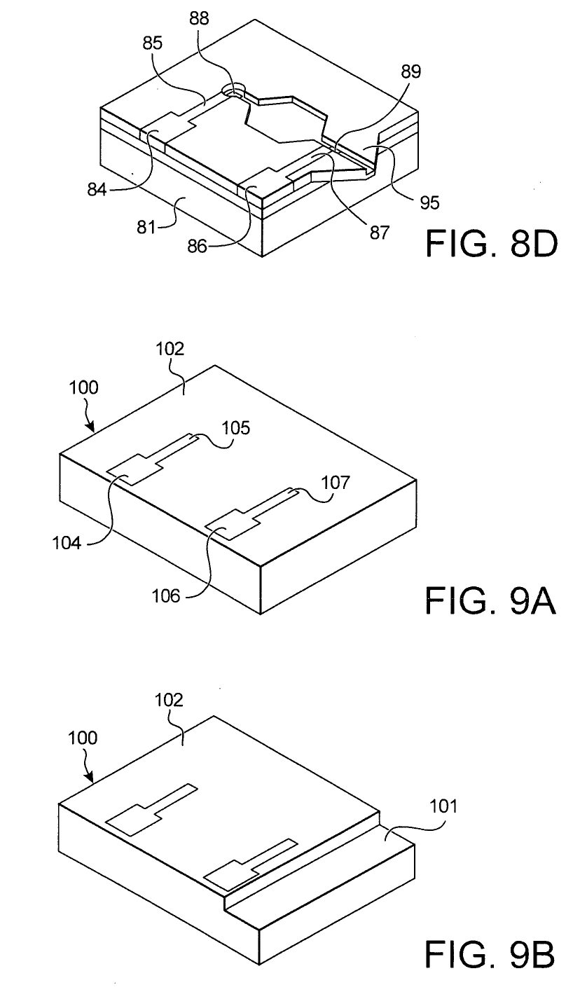

This embodiment is illustrated by FIGS. 8A-8D. It only uses a single SOI substrate. The electrodes, the conducting tracks and the electric connections are made in a single step with metal (aluminum, platinum, gold, etc.) “lift-off”.

FIG. 8A shows a SOI substrate 80 consisting of a silicon support 81 with a thickness of 500 μm, successively supporting a silicon oxide layer 82 with a thickness of 1 um and a thin layer 83 of silicon with a thickness of 25 μm.

FIG. 8B illustrates the making of the fluidic network in the thin layer 83. The fluid layer is obtained by DRIE etching.

The etching of the upper silicon layer 83 is:
either partial so as to retain a <<ground>> of silicon at the outlet channel and notably at the portion of the outlet channel opening into the tip type structure (as illustrated for the first and second embodiments),
or total in order to make an outlet channel of the <<slit>> type at the tip type structure (as illustrated in FIG. 8B).

Moreover, in the latter case, the etching may optionally be continued through the oxide layer 82 and then into the silicon support 81 in order to make a fluidic network with a great depth.

The achieved fluidic network comprises an inlet reservoir 91, an inlet channel 92, a microreactor 93 and an outlet channel 94. The etching of the thin layer 83 also defines the tip type structure 95.

The tip type structure 95 is then cleared by total chemical etching of the portion of the oxide layer 82 which has been exposed by etching of the layer 83 and also of the one which is found under the tip type structure 95 (see FIG. 8C).

A step for electrically insulating the fluidic network is then performed. This is achieved by thermal oxidization over 3 μm of thickness of the silicon of the thin layer 83.

The contact connections 84 and 86, the electrodes 88 (at the bottom of the inlet reservoir) and 89 (in the channel of the electro-nebulization nozzle) are then made by lifting off metal, as well as the conducting tracks 85 and 87 connecting each electrode to its corresponding contact connection (see FIG. 8D). The support 81 may then be cleaved for clearing the tip structure 95.

### Fourth Embodiment (Alternative to the Second Embodiment)

This is an alternative to the second embodiment wherein the use of a SOI substrate is replaced by the use of two silicon substrates.

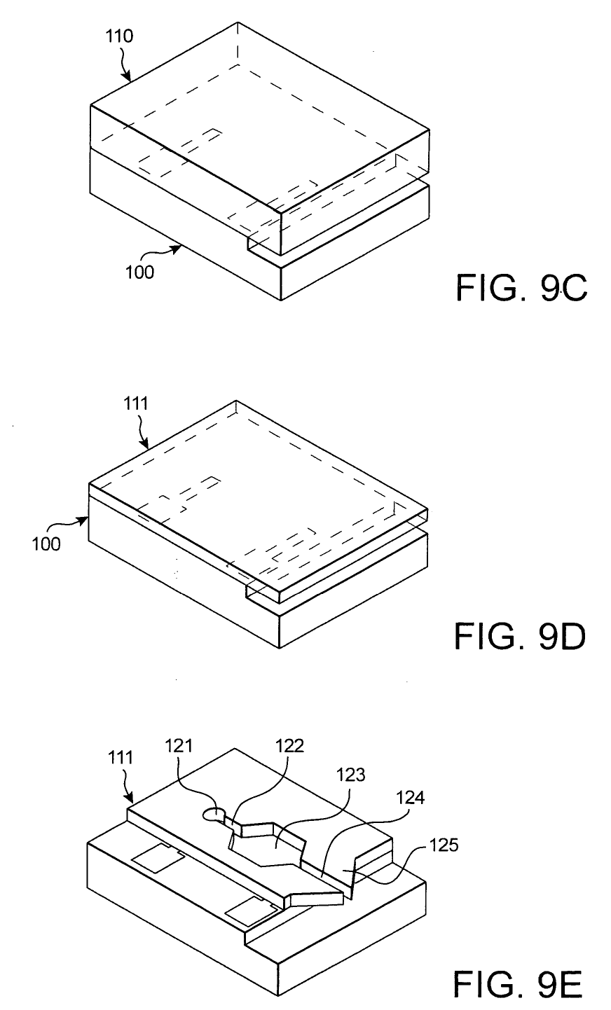

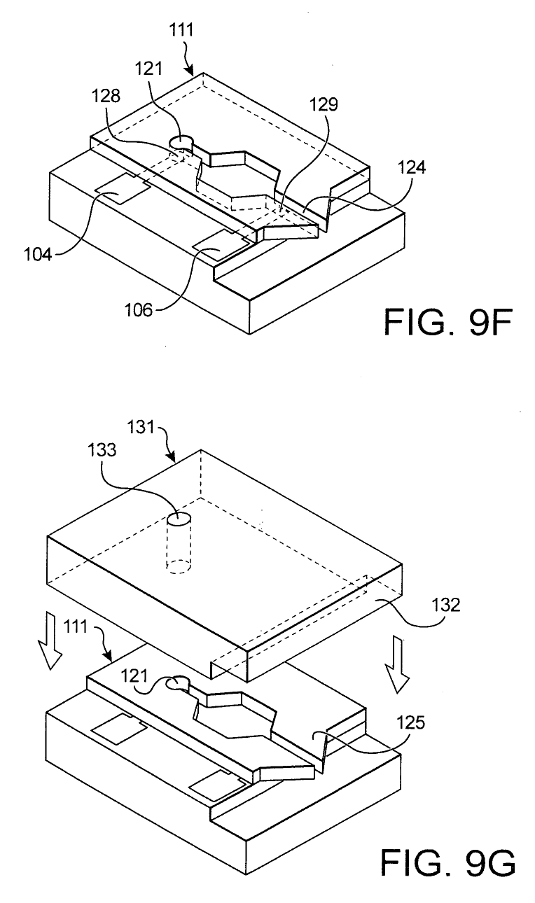

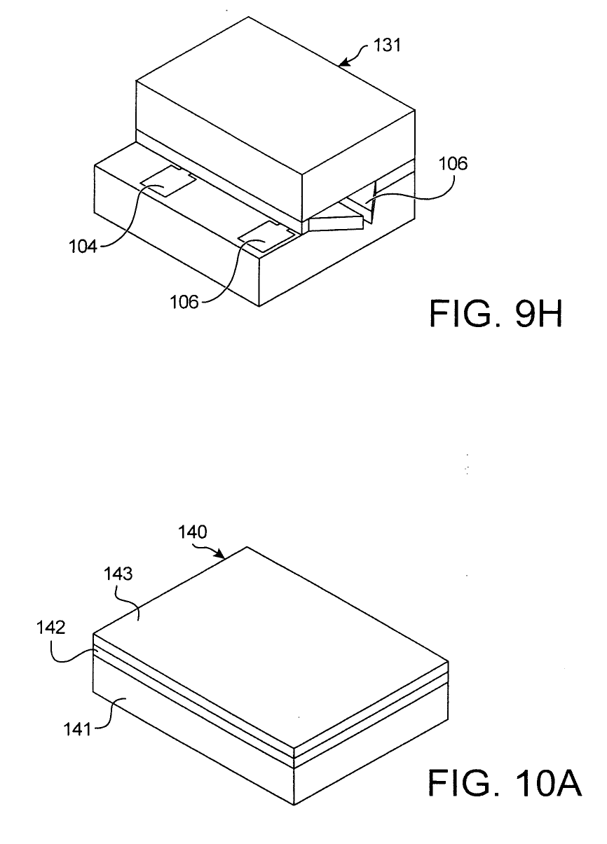

FIG. 9A shows a silicon substrate 100 having a face 102 on which two electrically conducting circuits are made by localized doping. The first conducting circuit is formed with the areas 104 and 105 and the second conducting circuit is formed with the areas 106 and 107.

The substrate 100 is then subjected to reactive ion etching (RIE) or chemical etching by means of KOH from the face 102, in order to obtain a recess 101 for providing the tip type structure and the cleaving of the substrate (see FIG. 9B).

Another silicon substrate 110 is then fixed by directly sealing it onto the face 102 of the substrate (see FIG. 9C).

The substrate 110 is then thinned until a thin layer 111 is obtained (see FIG. 9D)

The fluidic network is then made as shown in FIG. 9E. During this step, the thin layer 111 is partially or totally subjected to DRIE etching. The fluidic network comprises an inlet reservoir 121, an inlet channel 122, a microreactor 123 and an outlet channel 124. Etching of the thin layer 111 also defines the tip type structure 125.

As for the preceding embodiments, a step for electrically insulating the fluidic network is then performed. This is obtained by thermal oxidization.

The next step has the purpose of clearing the contact connections 104 and 106 (see FIG. 9F). For this, it is necessary to locally etch the thin layer 111 and the thermal oxide. This step may be performed by a laser etching technique. With it, the electrodes 128 and 129 respectively located at the bottom of the inlet reservoir 121 and at the bottom of the outlet channel 124 may also be cleared.

Step 9G illustrates the direct sealing of a cover plate 131 on the thin layer 111. The cover plate 131 includes an overhanging end portion 132 so that the plate 131 does not cover the tip type structure 125. It also includes a through-hole 133 intended for providing fluid communication with the inlet reservoir 121. The cover plate 131 may be a pyrex substrate.

Once the sealing is obtained, one proceeds with clearing. the tip type structure 125 and the contact connections 104 and 106. With a first cleavage of the plate 131 and a cleavage of the substrate 100 the electronebulization nozzle may be freed. With a second cleavage of the plate 131, the contact connections 104 and 106 may be freed.

### Fifth Embodiment

This embodiment uses an SOI substrate and a pyrex substrate (<<Corning>> 7740) as a cover. The electrodes, the conducting tracks and the electrical contact connections are made by depositing metal (aluminium, platinum, gold . . . ) and by photolithography on the lower face of the pyrex cover, wherein they are <<inlaid>>.

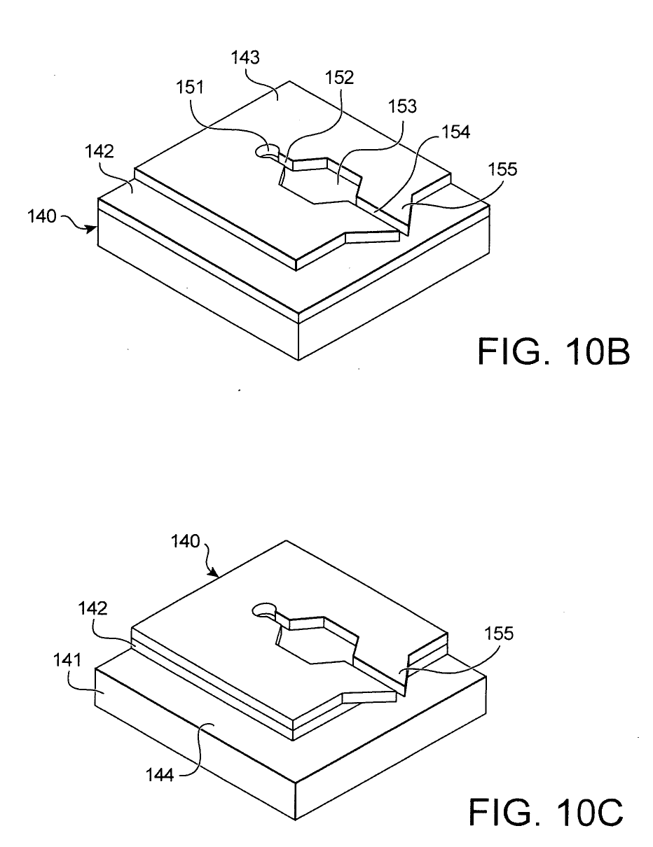

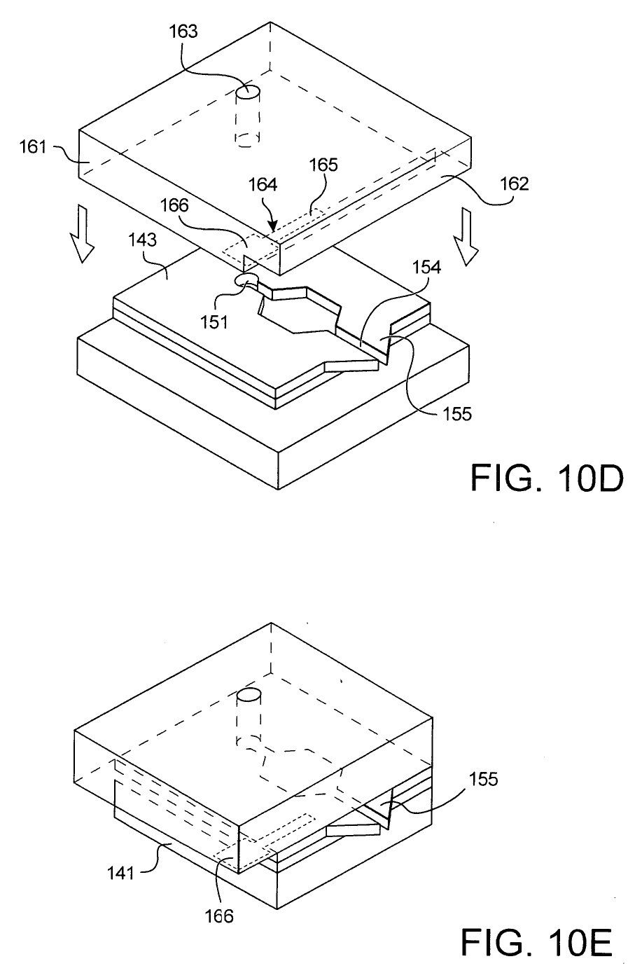

FIG. 10A shows an SOI substrate 140 consisting of a silicon support 141 with a thickness of 500 μm, successively supporting a silicon oxide layer 142 with a thickness of 1 μm and a thin silicon layer 143 with a thickness of 25 μm.

FIG. 10B shows the device obtained after a step for DRIE etching the thin layer 143. The fluidic network may be made by etching. The latter comprises an inlet reservoir 151, an inlet channel 152, a microreactor 153 and an outlet channel 154. Etching of the thin layer 143 is also performed on two edges of the substrate 140 until the oxide layer 142 is exposed. It allows the tip type structure 155 to be defined.

This etching step is standard in microtechnology. It uses a silicon oxide mask with a thickness of 5,000 Å produced in an oven at 1,050° C. in a humid atmosphere. A 1.3 μm layer of photoresist <<Shipley S 1813 SP15>> is then spread out over a <<SVG>> track (adherence promoter: HMDS vapor). The 1× patterns are insolated, and then developed with <<Shipley MIF 310>> on an <<SVG>> track. The oxide mask may then be etched with reactive ion etching (RIE) under a CHF₃/O₂ mixture, by <<Nextral 330>> for example. The resin is then removed (by the so-called stripping method) with Posistrip or fuming HNO₃. Silicon is then DRIE-etched under an SF₆/O₂ mixture at 110° C. with <<Alacatel ICP 601^{E}>> for example. Finally, the oxide mask is stripped with 10% HF until dewetting occurs.

The tip type structure is then cleared by chemically etching the oxide layer 142. This chemical etching may be performed in a bath called BOE (“Buffer Oxide Etchant”): HF/NH₄F). The device illustrated in FIG. 10C is obtained, which shows the overhanging tip type structure 155. This figure also shows that the oxide previously exposed on the other edge of the substrate 140, was removed during etching in order to expose the edge 144 of the support 141.

As for the previous embodiments, electrical insulation of the fluidic network is obtained by thermal oxidization. This oxidization takes place in an oven at 1,150° C. in a humid atmosphere.

FIG. 10D illustrates the direct sealing of a cover plate 161 on the thin layer 143. The cover plate 161 includes an overhanging end portion 162 so that the plate 161 does not cover the tip type structure 155. It also includes a through-hole 163 for providing fluid communication with the inlet reservoir 151. The cover plate 161 may be a pyrex substrate. FIG. 10D also shows that the plate 161 includes on the face intended to come into contact with the thin layer 143, a metal track 164 positioned so that its internal end 165 is used as an electrode for the outlet channel 154 and that its external end 166 is used as an electrical contact connection.

This direct sealing step is performed at 400° C. It requires proper preparation of the surfaces, i.e:
polishing the pyrex plate with a solution of KOH/1% HF containing a suspension of colloidal silica, followed by standard RCVA SC1 cleaning (NH₄OH/H₂O₂/H₂O 1/4/20 at 70° C.),
cleaning the oxidized silicon substrate with Caro's acid (H₂SO₄/H₂O₂ 2/1 at 140° C.) followed by standard RCVA SC1 cleaning (NH₄OH/H₂O₂/H₂O 1/4/20 at 70° C.).

Structuration of the pyrex cover (<<etching>> and <<inlaying>> the metal track) is performed according to the following technological steps:

Performing Etchings for a Cut-Out Recess and <<Box for Metal Track>>:
Cr/Au/Cr/Au (50 Å/3,000 Å/50 Å/3,000 Å) coating,
spreading out <<Shipley S 1813 SP15>> photoresist over a <<SVG>> track, with thickness of 1.3 μm,
insolation of 1× and ‘cut-out recesses’ patterns,
development on the <<SVG>> track with the <<Shipley MIF 319>> developer,
Au KI/I₂ etching,
Cr etching with the solution called Cr Etch,
removal of the resin by stripping with the use of <<Posistrip>> or fuming HNO₃,
spreading out <<Shipley S 1813 SP15>> photoresist over a <<SVG>> track, with a thickness of 1.3 μm,
insulation of the ‘cut-out recesses and metal track boxes’ and 1× patterns,
development on an <<SVG>> track by means of the developer <<Shipley MIF 319>>,
Au KI/I₂ etching,
Cr etching with the solution called “Cr Etch”,
glass etching over 25 μm with 10% HF,
removal of the resin by stripping with the use of <<Posistrip>> or fuming HNO₃.

Producing the <<Inlaid>> Metal Strip:
full sheet Au KI/I₂ etching,
full sheet Cr etching with the “Cr Etch” solution,
glass etching over 5,000 Å with a 10% HF solution,
stripping with Au KI/I₂,
Cr stripping with the “Cr Etch” solution,
Cr/Au 50 Å/3000 Å coating,
polishing until the gold and glass are coplanar,
SiO₂ deposition by PECVD at 300° C.-<<STS Multiplex>>,
densification of the oxide in an oven under a neutral gas.

Opening the Contacts:
spreading out of <<Shipley S 1813 SP15>> photoresist over an <<SVG>> track, with a thickness of 1.3 μm,
insulation of the 1× patterns,
development on an <<SVG>> track with the <<Shipley MIF 319>> developer,
SiO₂ etching with the RIE method <<Nextral 330>> —CHF₃/O₂ gaz,
removal of the resin by “stripping” with the use of Posistrip or fuming HNO₃.

Once the sealing is obtained, one proceeds with clearing the tip type structure 155 and the contact connection 166 by cleaving the support 141 (see FIG. 10E). With a first cleavage the electronebulization nozzle may be freed. With a second cleavage, the contact connection may be freed.

### Sixth Embodiment (Alternative of the Fifth Embodiment)

This is an alternative to the fifth embodiment in which the use of an SOI substrate is replaced with the use of two silicon substrates.

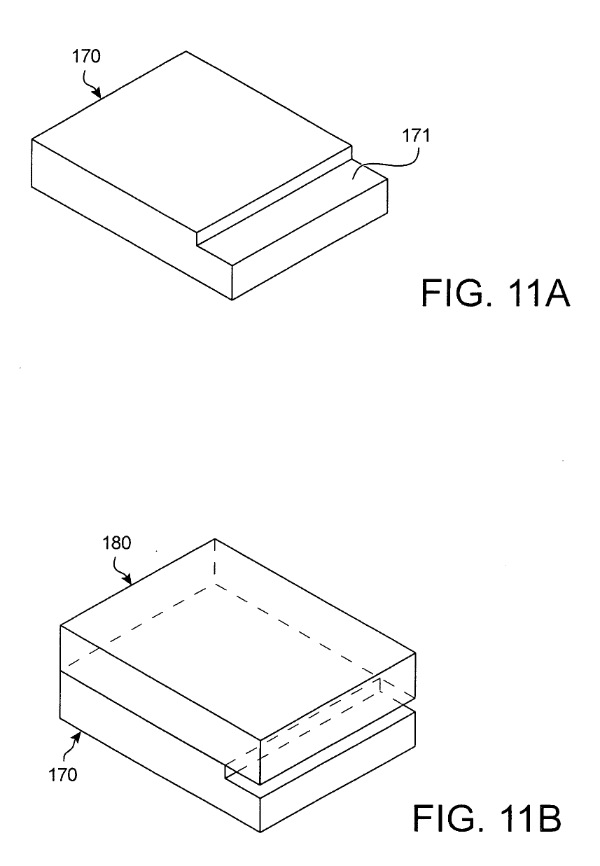

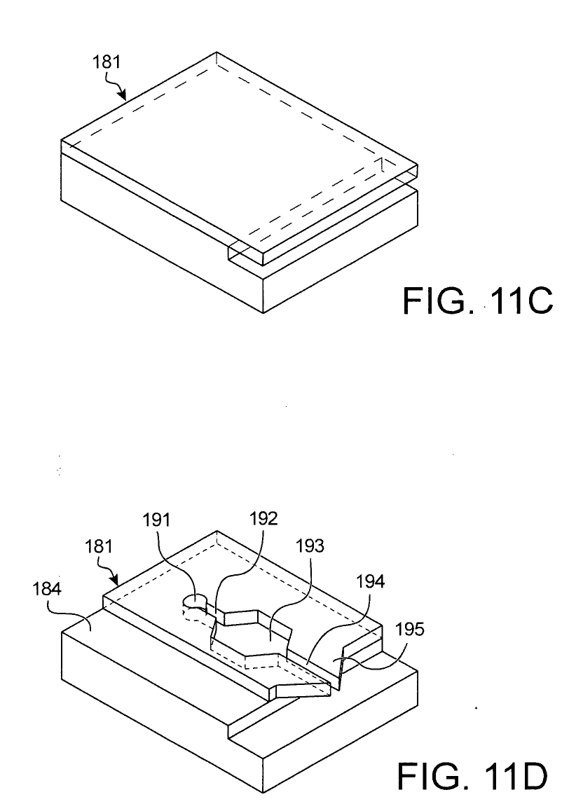

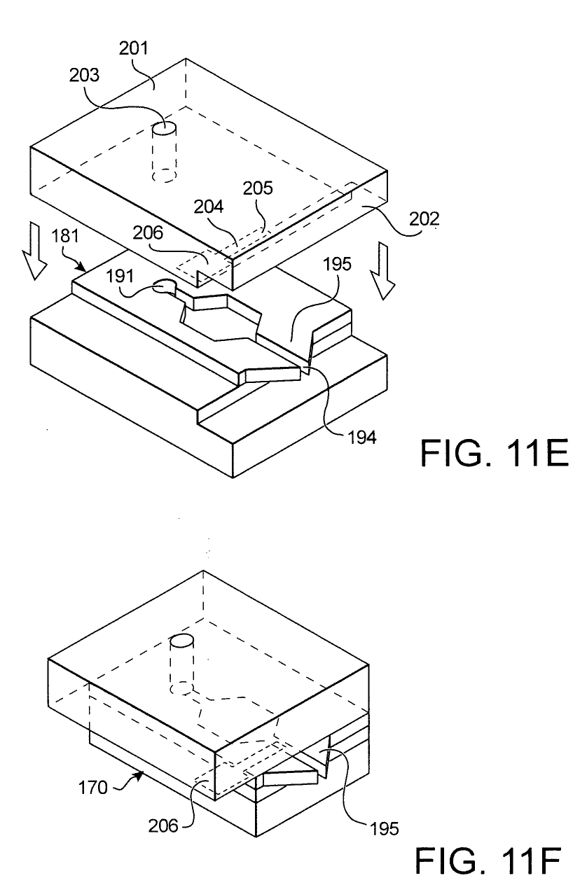

FIG. 11A shows a first silicon substrate 170 having a recess 171 for providing the tip type structure and the cleavage of this substrate. The recess is obtained by RIE, DRIE or KOH.

FIG. 11B shows that a second silicon substrate 181 was fixed on the etched face of the substrate 170. This attachment was obtained by direct sealing.

FIG. 11C shows that the second substrate was thinned in order to obtain a thin silicon layer 181.

The fluidic network is then achieved as shown in FIG. 1D. During this step, the thin layer 181 is subjected to DRIE etching. The fluidic network comprises an inlet reservoir 191, an inlet channel 192, a microreactor 193 and an outlet channel 194. The etching of the thin layer 181 also defines the tip type structure 195 and allows the edge 184 of the substrate 170 to be exposed.

As for the previous embodiments, a step for electrically insulating the fluidic network is then performed. This is obtained by thermal oxidization.

FIG. 11E illustrates the direct sealing of a cover plate 201 on the thin layer 181. The cover plate 201 includes an overhanging end portion 202 so that the plate 201 does not cover the tip type structure 195. It also includes a through-hole 203 intended to provide fluid communication with the inlet reservoir 191. The cover plate 201 may be a pyrex substrate. FIG. 11E also shows that the plate 201 includes, on the face intended to come into contact with the thin layer 181, a metal track 204 positioned so that its internal end 205 is used as an electrode for the outlet channel 194 and that its external end 206 is used as an electrical contact connection.

Once the sealing is achieved (see FIG. 11F) one proceeds with clearing the tip type structure 195 and the contact connection 206 by cleaving the substrate 170. With a first cleavage the electronebulization nozzle may be freed. With a second cleavage the contact connection may be freed.

Circuit for Electro-Osmotic Pumping

In order to externally impose electro-osmotic pumping in the different reactors of the micro-fluid device, it is possible to use a card with tips produced by MESATRONIC S.A. of Voiron (Isere, France). Such a card is an electrical circuit which may withstand high voltages (10 kV) and is provided with a set of platinum tips which will simultaneously dip in different reservoirs of the device. Different electrical potentials may therefore be imposed at different points of the device in order to manage the different flows thereof.

Use of the Invention

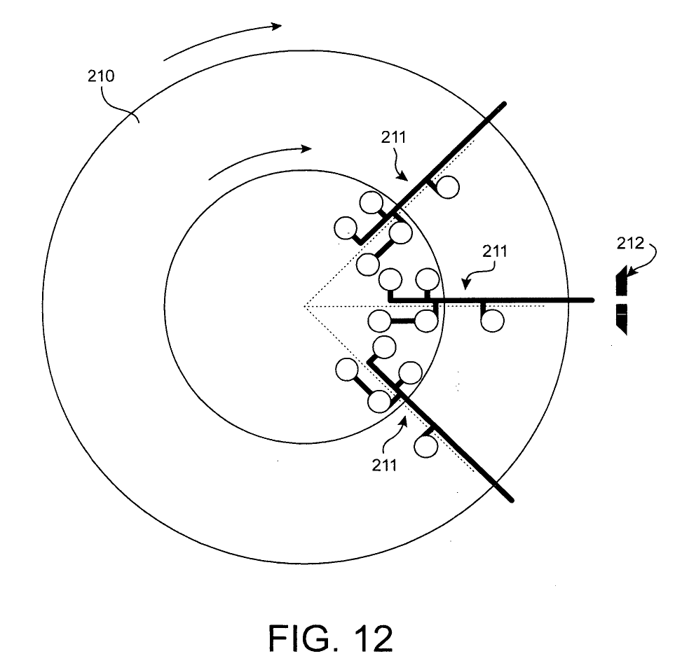

FIG. 12 shows how the set of <fluidic network and electronebulization nozzle>> devices 211 may be distributed on a circular substrate 210 in order to have a single object with N micro-fluidic devices, thereby facilitating a use with high throughput of analyses.

In this configuration, the fluidic networks are patterned radially, along the radii of the circular substrate 210. N electro-nebulization nozzles are then distributed along the circumference for the substrate, and it is sufficient to manually or automatically rotate the latter in order to provide a continuous series of analyses with a mass spectrometer 212. For this, the support of the substrate may be mounted on a rotary axis. Preparation of the samples may itself be achieved beforehand in parallel on the N devices.

### INDUSTRIAL APPLICATIONS

The possible applications of the invention are all those which use as a detection method, mass spectrometry with an “electrospray ionization” (ESI) technique as an interface.

As an example the analysis of samples may be mentioned in the biomedical sector and in the pharmaceutical industry:
genetic analyses,
proteomics (identification of proteins . . . ),
development of drugs.

1-7. (canceled)

8. An on-chip laboratory comprising a support, at least one fluidic network, at least one fluid inlet orifice connected to the fluidic network and at least one fluid outlet orifice connected to the fluidic network, a thin layer integral with the support and in which the fluidic network and an electronebulization nozzle are made, the electronebulization nozzle overhanging relatively to the support and comprising a channel, one end of which is connected to the fluidic network and the other end of which forms said fluid outlet orifice, the channel being fitted with electrical conduction means forming at least one electrode, wherein the thin layer is a layer fixed by direct sealing onto the support.

9. The on-chip laboratory according to claim 8, wherein as the support is in a semiconducting material, the electrical conduction means are a doped portion of said support.

10. The on-chip laboratory according to claim 8, wherein the support is in a conducting material.

11. The on-chip laboratory according to claim 8, comprising a cover hermetically covering the fluidic network, this cover being provided with a fluid access means at the fluid inlet orifice.

12. The on-chip laboratory according to claim 8, comprising a cover hermetically covering the fluidic network, this cover being provided with a fluid access means at the fluid inlet orifice and being provided with said electrical conduction means.

13. The on-chip laboratory according to claim 12, wherein the cover is in a conducting material.

14. The on-chip laboratory according to claim 12, wherein the cover is in a semiconducting material, the electrical conducting means comprising a doped portion of the cap.
